(19) United States
(12) Patent Application Publication
(10) Pub. No.: US 2007/0157775 A1
(43) Pub. Date: Jul. 12, 2007

(54) Method and device for making patterns

(76) Inventor: Alice Huff, Forest Park, OH (US)

Correspondence Address: Mark F. Smith, 905 Ohio Pike, Cincinnati, OH, 45245, US

(21) Appl. No.: 11/328,351

(22) Filed: Jan. 9, 2006

(51) Int. Cl. B26D 1/00

(52) U.S. Cl. 83/13; 428/131

(57) ABSTRACT

A relatively inexpensive and easy to use method and device for directly making a pattern of a relatively complex surface such as, for example, around a door frame, a window frame, building molding, and other similar surfaces. In a preferred embodiment of the invention, the device for directly making patterns comprises a planar sheet of material having separating means, such as a plurality of perforations, for allowing the planar sheet of material to be easily severed into a desired shape. In another preferred embodiment of the invention the device includes a plurality of outwardly extending dimples effective for recording an outer surface contour of an object.

### BACKGROUND OF THE INVENTION

The present invention relates to a method and device for making patterns and more particularly, a method and device for making patterns of irregular surfaces.

The making of patterns of irregular shaped surfaces has been difficult. This is particular true in making patterns for home improvement or crafts whereby materials such as carpet, flooring, wall tile, molding, and the like must be cut to fit around edges of objects that are irregular in shape. In the past, patterns around such objects have been formed by either approximating the shape of a surface and making refinements to the pattern until a satisfactory pattern is achieved or by use of mechanical pattern devices. Mechanical pattern devices typically use moveable pins or the like that move and press against the surface being modeled. The amount of movement of the pins relative to one another creates a mechanical pattern. Unfortunately, such devices are relatively complicated and still require the user to transform the pattern formed by the pins into a useable pattern for the project.

Until now there has not been a relatively inexpensive and easy to use method or device for directly making a pattern of a relatively complex surface. Further, until now there has not be a relatively inexpensive and easy to use method of directly making a pattern of the contour of a surface such as, for example, around a door frame, a window frame, building molding, and other similar surfaces.

### SUMMARY OF THE INVENTION

The present invention is a device for directly making patterns comprising a planar sheet of material having separating means, such as a plurality of perforations, for allowing the planar sheet of material to be severed into a desired shape.

In a preferred embodiment of the invention the perforations are sized to permit the planar sheet of material to be easily severed into a shape to conform to an irregular contour.

In another preferred embodiment of the invention the planar sheet of material is flexible.

In another preferred embodiment of the invention the planar sheet of material includes means for depositing an image thereon.

In another preferred embodiment of the invention the perforations extend outwardly such that they can record a pattern when pressed against the surface of an object.

In a preferred embodiment of the invention the planar sheet of material is formed out of paper.

In a preferred embodiment of the invention the planar sheet is formed out a fibrous material.

In a preferred embodiment of the invention the planar sheet includes a tacky surface for removably attaching to the surface of an object.

In another preferred embodiment of the invention the device for making patterns comprises a flexible planar sheet of material effective for placement along the surface contour of an object and a press having a surface for pressing against and severing the planar sheet of material along the surface contour of the object.

In a preferred embodiment of the invention the device for making pattern is formed into sheets of material.

In a preferred embodiment of the invention the device for making patterns is formed into a continuous roll.

Another preferred embodiment of the invention is a method of making a pattern comprising the steps of holding a planar sheet of material against a surface of an object; pressing down along the edge of the object to sever the planar sheet of material along the edge of the object to form a pattern; wherein the planar sheet of material having means for easily separating along the edge of the object.

In another preferred embodiment of the invention, the method includes using a press for pushing against and sever the planar sheet of material along the edge of an object.

Another preferred embodiment of the invention is a method of making a pattern comprising the steps of holding a planar sheet of material having perforations extending outwardly from the planar sheet of material, placing an object along the upper surface of the planar sheet of material, and pressing downwardly on the object such that the planar sheet of material records a pattern thereon.

In another preferred embodiment of the invention, the planar sheet of material is severed along the edges of the object to form a pattern.

Other aspects, advantages and embodiments of the invention will be made apparent from the following description and the appended claims.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a top planar view of a preferred embodiment of a device for making patterns of the subject application showing the planar sheet material having a plurality of perforations therein;

FIG. 2 is a side elevation view of the device for making patterns of FIG. 1;

FIG. 3 is a perspective view of the device for making patters of FIG. 1 showing the device being placed along the contour surface of an object and the planar sheet of material being severed along the contour surface of the object;

FIG. 4 is a top plan view of the device of FIG. 1 showing the planar sheet of material having been severed along the surface of an object to form a pattern;

FIG. 5 is an enlarged view of a section of the planar sheet of material of FIG. 1 showing the severed perforations;

FIG. 6 is a perspective view of another preferred embodiment of the device for making patterns showing a plurality of planar sheets of material being stacked up along the edge of an object to form a three-dimensional pattern of the surface of the object;

FIG. 7 is an enlarged view of the device for making patterns of FIG. 6;

FIG. 8 is a perspective view of another embodiment of the device for making patterns showing a press being used to push downwardly along the surface of the planar sheet of material to sever the material along the edge of the surface of the object;

FIG. 9 is an enlarged view showing the device for making patterns of FIG. 8;

FIG. 10 is a side view of another preferred embodiment of the device for making patterns showing the planar sheet of material having a plurality of perforations extending outwardly from the planar surface material and an object placed thereon;

FIG. 11 is a planar top view of the device for making patterns of FIG. 10 showing the contour of the surface of the object formed along the upper surface of the planar sheet of material;

FIG. 12 is a flowchart illustrating the methodology of a method of making patterns of the subject application;

FIG. 13 is a flowchart illustrating the methodology of another embodiment of the invention for making a pattern of an object.

### DETAILED DESCRIPTION OF THE INVENTION

The subject invention is a method and device for making patterns. The novel feature of the subject invention is the ease by which a pattern of a complex surface may be made. This application however, is not intended to be limited by the specific terms so selected, and it is to be understood that each specific term includes all equivalents that operate in a similar manner to accomplish a similar result.

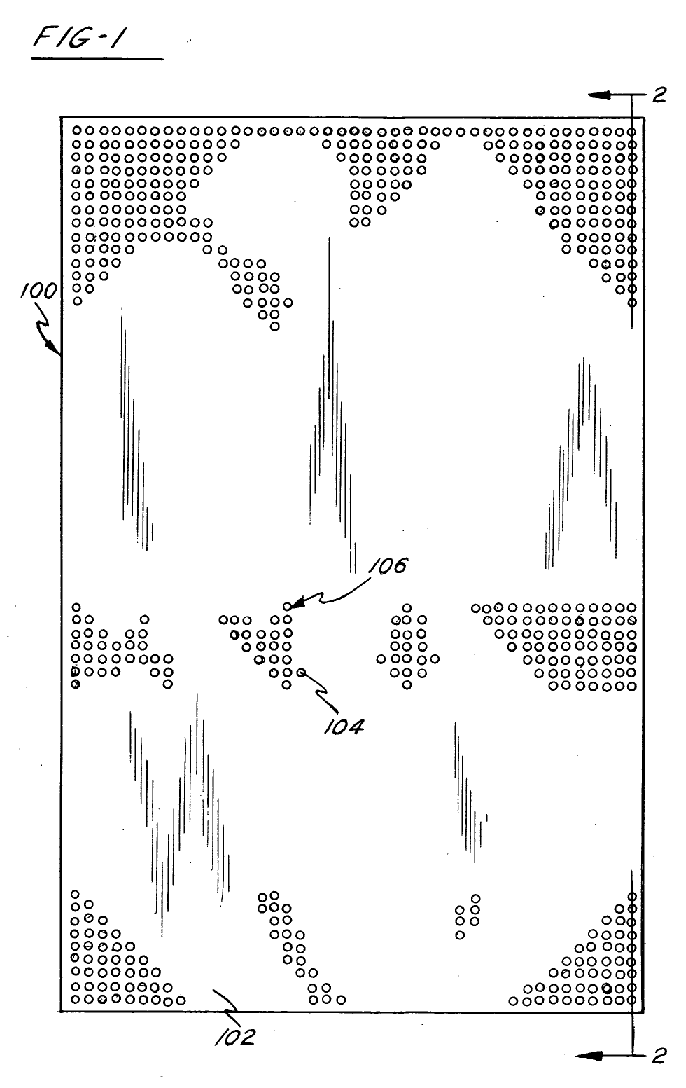

Referring to FIGS. 1 through 5, the device for making patterns 100 of the subject invention is shown comprising a planar sheet of material 102 having a plurality of separating means 104. Preferably the separating means 104 comprises a plurality of elongated perforations or apertures as shown separated by a web 105. In a preferred embodiment of the invention as shown, the separating means 104 comprises a plurality of apertures 106 such that the aperture density is sufficient for permitting the planar sheet of material 102 to be easily severed to conform to any given configuration. It should be understood that while circular shaped apertures, such as those show, are preferred, elongated perforations in the planar surface material may also be utilized having appropriate geometric shapes for allowing the planar sheet of material to be easily severed. For example, the elongated perforations may be in the shape of a “L” or star shape to allow the planar sheet to be easily severed.

It should be understood that the separating means 104 are sized such that they are effective to permit the planar sheet of material to be easily severed to conform to any given configuration. Preferably, the planar sheet of material 102 is formed from a fibrous material like paper, such as a woven paper, recycled paper, bond paper, card stock, tissue paper, crepe paper and card board material having various calipers, base weights, stiffness, and textures. For patterns requiring relatively a high degree of accuracy, the particular paper selected to form the planar sheet of material 102 should be such to allow the greatest degree of flexibility, such as for example a tissue or crepe paper having numerous, preferably relatively small, separating means 104. In this way a relatively accurate and precise separation can be made along the edge or surface of the object to form a pattern. For patterns requiring less accuracy and precision, the particular planar sheet of material 102 may be formed from a material, such as paper providing relatively less flexibility, such as a card stock or card board, and the separating means 104 can be larger and more spaced. It should also now be apparent that one side if the planar sheet of material 102 may be provided with a tacky surface 103, such as by use of an a tacky adhesive, that will hold the sheet in place while being separated. Thus, making the device 100 convenient for use on surfaces such as near ceilings, walls, etc,

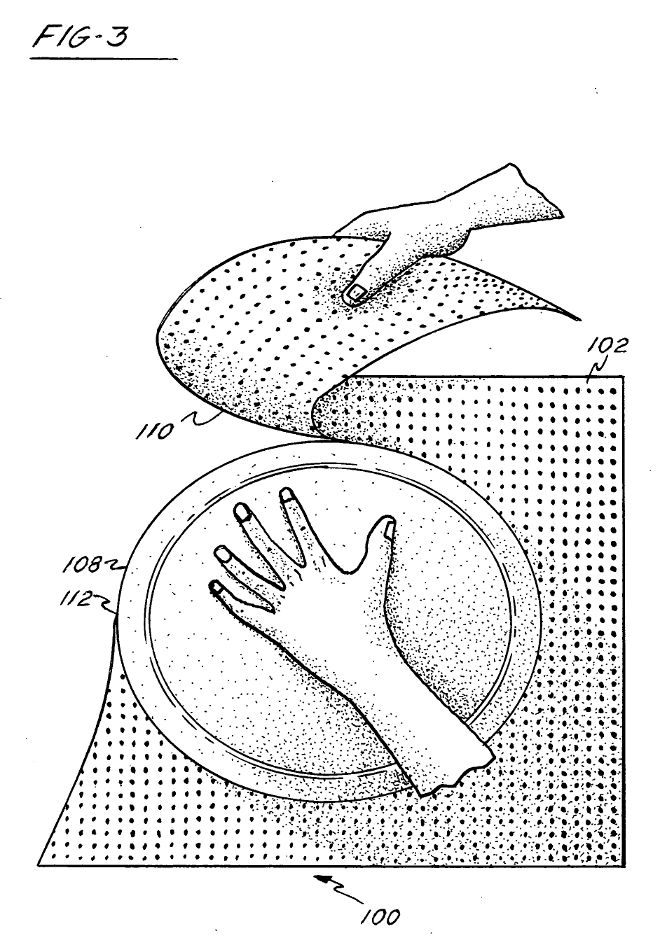

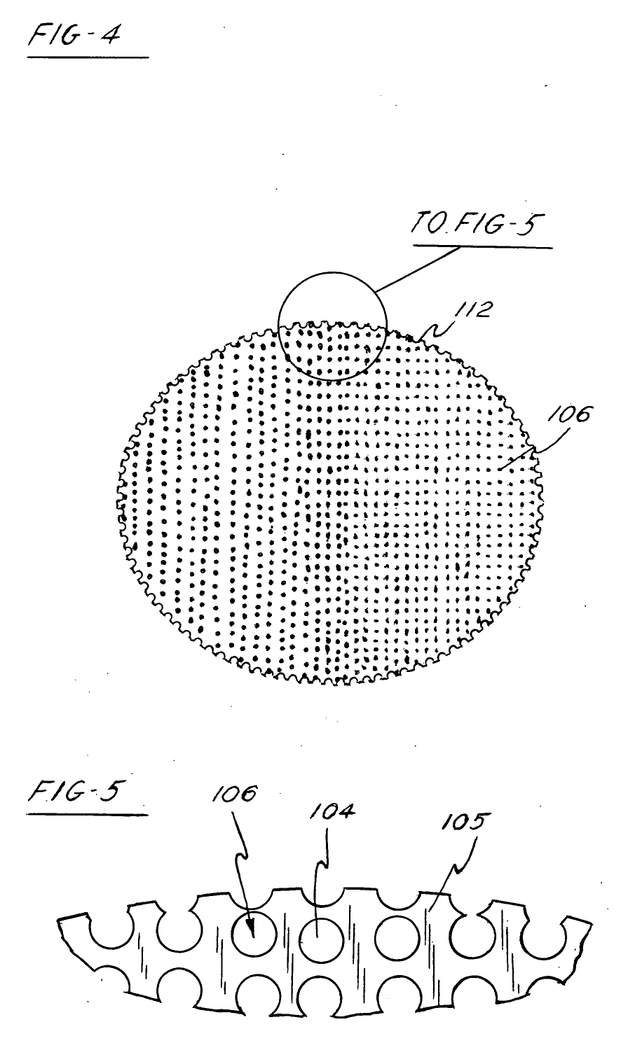

Referring to FIGS. 3 and 4, the device for making patters 100 is shown placed against the surface of an object 108 such that the planar sheet of material 102 is in direct contact with the edge 110 of the surface of the object. As illustrated, the planar sheet of material 102 is severed along the edge 110 of the object 108 to form a pattern. The severed edge 112 of the planar sheet of material 102 forms a contour that corresponds to the contour of the edge 110 of the object 108. Thus a pattern of the edge is created. For objects of large size, planar sheets of material may be attached together to form a large planar sheet of material that can then be used to form a pattern.

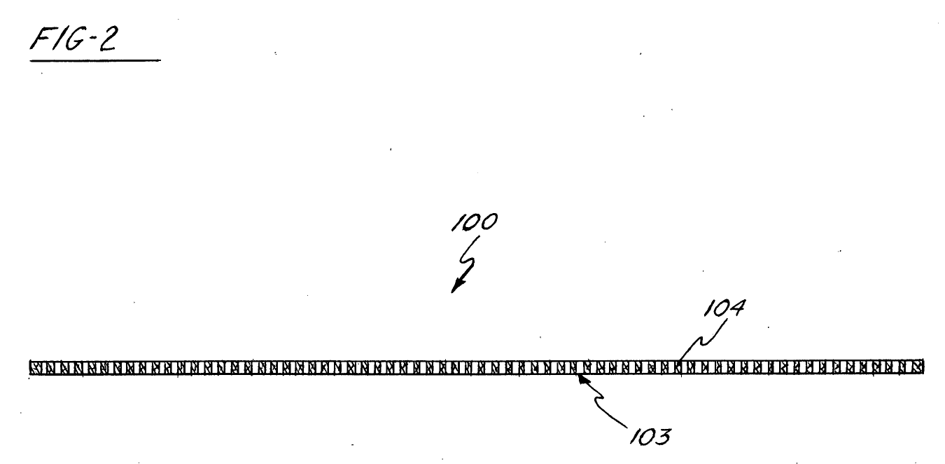

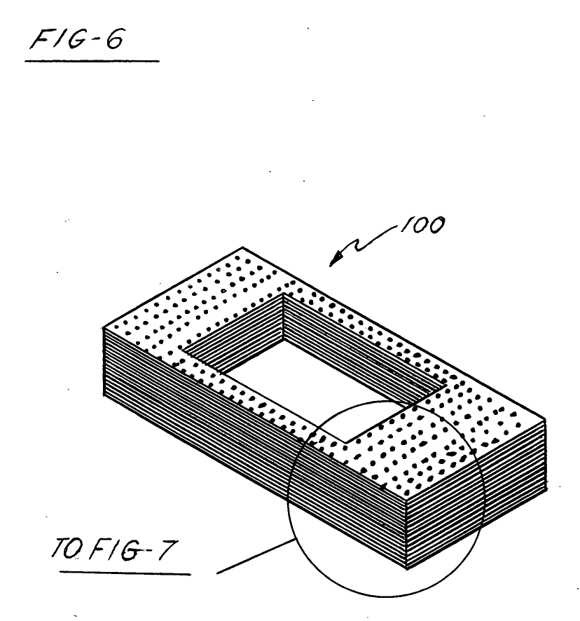

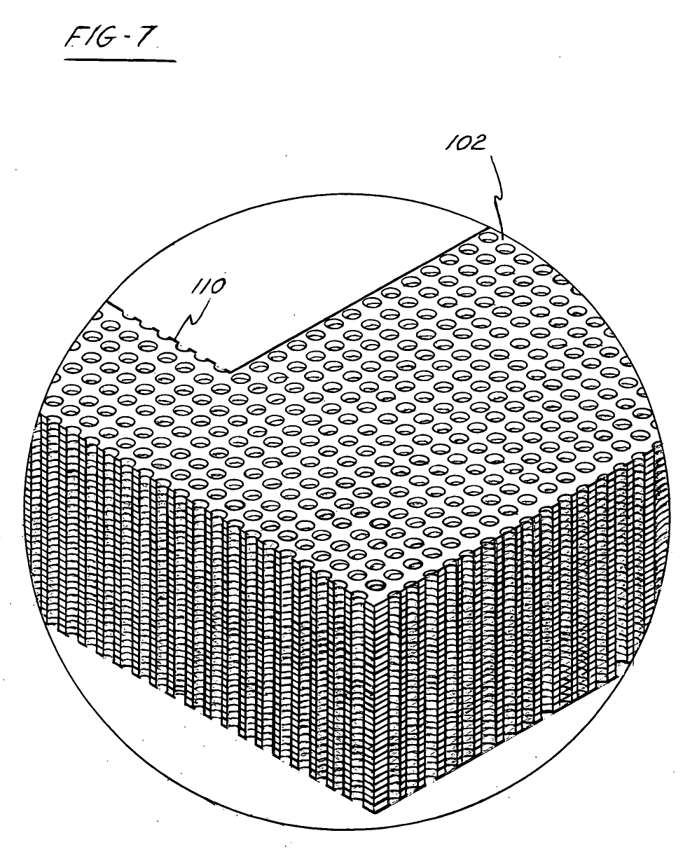

Referring to FIGS. 6 and 7 is another embodiment of the device for making patterns 100 showing a plurality of planar sheets of material 102 stacked on top of one another. The planar sheets of material 102 can each be severed along the corresponding edge 110 of an object (not shown) such that a three-dimensional pattern of the contour of the surface of the object is formed. It should be understood that the individual planar sheet of material 102 selected should be selected to have the desired thickness “T” (FIG. 2). For example, for objects having an outer contour that various slightly in height, the thickness T of each planar sheet of material may be relatively large. For objects having an outer contour that varies greatly in height, the thickness T of each planar sheet of material should be relatively small. It should now be understood that the smaller the thickness T of each planar sheet of material, the greater the accuracy of the pattern produced.

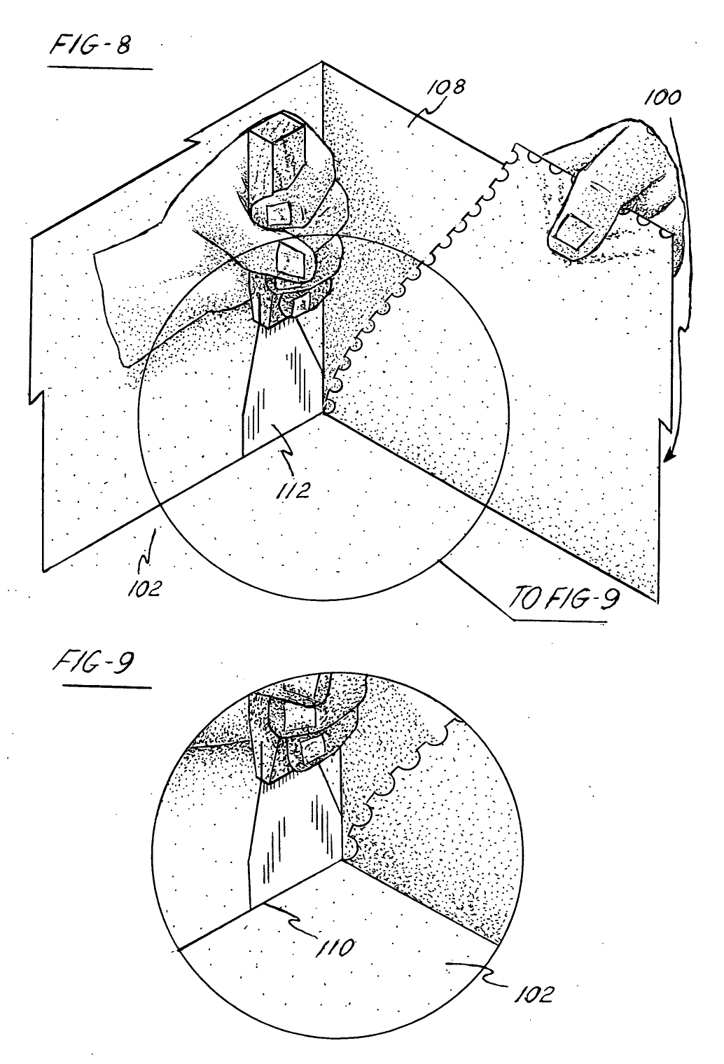

Referring to FIGS. 8 and 9, another embodiment of the device for making patterns 100 is shown further comprising a press 112 for use in pressing down on the surface of the planar sheet of material 102 along the edge 110 of the surface of the object 108 thereby severing the planar sheet of material 102 to form the desired pattern. It should be understood that the use of the press 112 permits the planar sheet of material 102 to be more easily severed and more accurately severed along the edge 110 thereby producing a more accurate pattern.

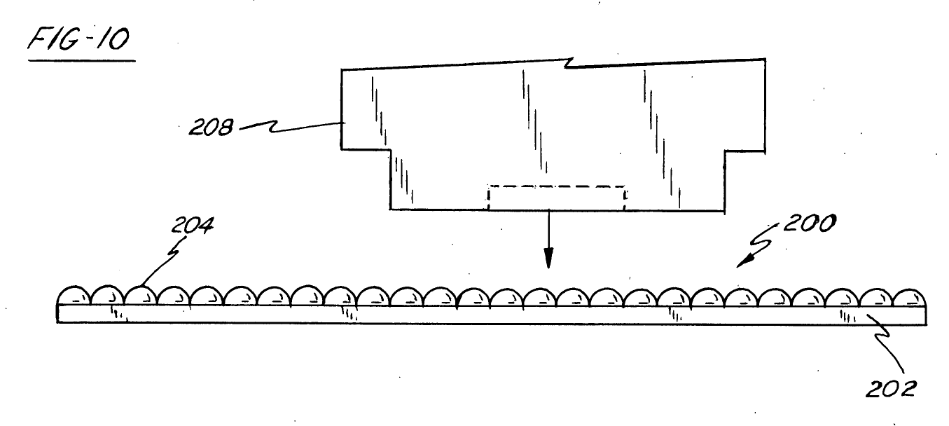

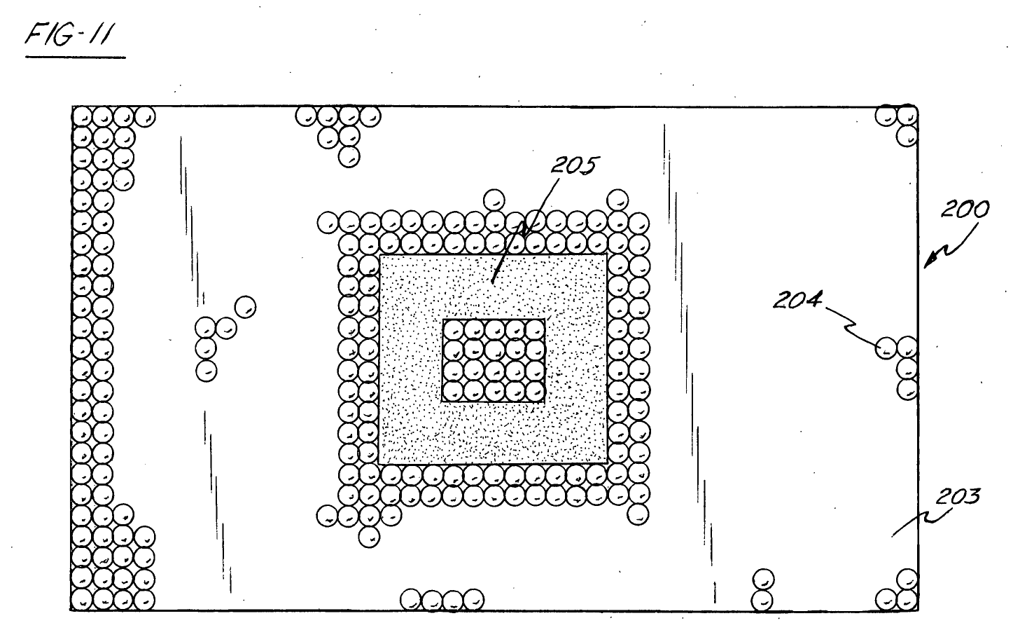

Referring to FIGS. 10 and 11, another embodiment of the device for making patterns 200 is shown comprising a planar sheet of material 202 having an upper surface 203 and a plurality of outwardly extending dimples 204. In use of making patterns, an object 208 is placed on the upper surface 203 of the planar sheet of material 202 or the upper surface 203 is pressed against the surface of the object 208 such that the surface of the object 208 presses against the outwardly extending dimples 204 to push the dimples 204 downwardly to flatten the dimples and form a contour 205 of the surface of the object 208 along the upper surface 203 of the planar sheet of material 202, as illustrated in FIG. 11. It should now be understood that the dimple density of the planar sheet of material 202 should be sufficient for permitting the planar sheet of material 202 to accurately show the contour 205 of the object 208. The planar sheet of material 202 can then be severed along the edges of the contour 205, such as by cutting, to form the desired pattern of the surface of the object 208.

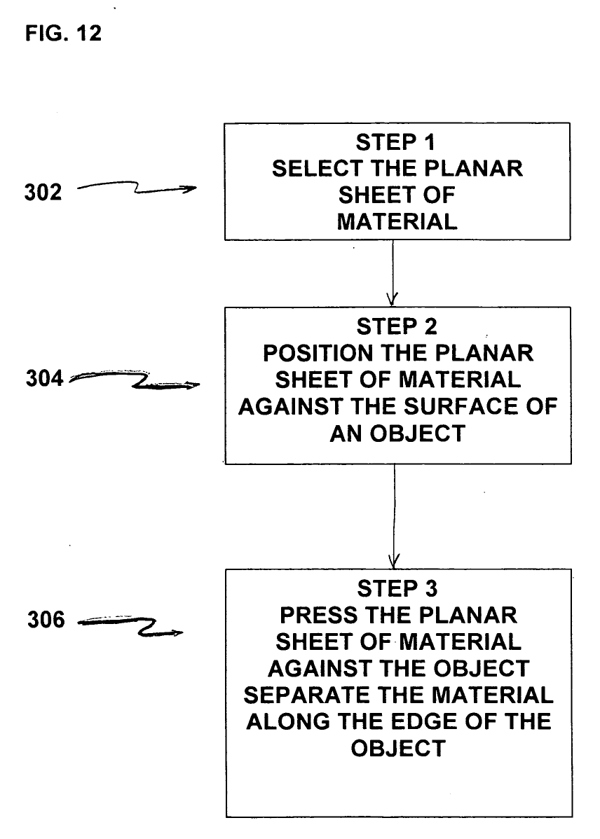

Referring to FIG. 12, the methodology of making patterns is illustrated. A planar sheet of material is selected for the desired application 302 (step 1) of the resulting pattern. As described hereinabove, the particular material forming the planar sheet of material and separating means is selected based on the specific use of the resulting pattern. The planar sheet of material is then positioned against the object along the edge of the surface for the pattern 304 (step 2). The planar sheet of material is then pressed against the object such that the separating means operates to sever the planar sheet of material along the edge of the object thereby forming the desired pattern 306 (step 3).

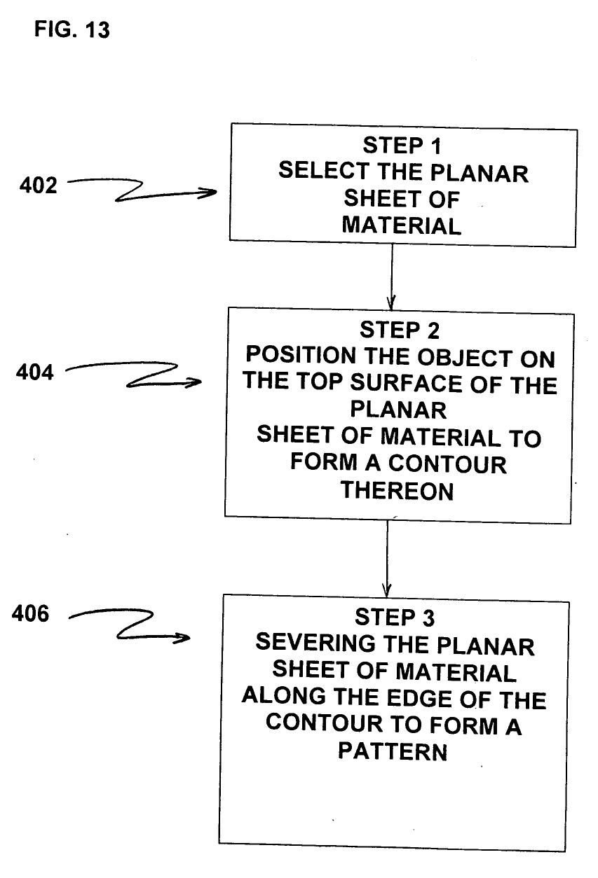

Referring to FIG. 13, the methodology of another embodiment of making patterns is illustrated. A planar sheet of material having a plurality of outwardly extending dimples is selected 402 (step 1). An object is then placed on the upper surface of the planar sheet of material or the upper surface is pressed against the surface of the object such that the surface of the object presses against the outwardly extending dimples to push the dimples downwardly into the surface of the planar material to form a contour of the contacting surface of the object along the upper surface of the planar sheet of material 404 (step 2). In selecting the planar sheet of material, the dimple density should be sufficient for permitting the planar sheet of material to accurately show the contour of the object. The planar sheet of material is then severed along the edges of the contour to form the desired pattern of the surface of the object 406 (step 3).

It should now be apparent that the device for making patterns of the subject application is relatively inexpensive and easy to use and effective for directly making a pattern of a relatively complex surface such as around a door frame, a window frame, building molding, and other similar surfaces. It should also now be apparent that the device for making patterns of the subject application is a relatively inexpensive and easy to use system that can be used to make three-dimensional patterns of objects. It should also now be apparent that the device for making patterns of the subject application can be used for making patterns of clothing or other such items by placing the sheet of planar material over the article and separating the planar sheet of material along the boundary of the article.

While the device and method described constitute preferred embodiments of the invention, it is to be understood that the invention is not limited to the precise device and method, and that changes may be made therein without departing from the scope of the invention which is defined in the appended claims.

What is claimed is:

1. A device for directly making patterns comprising a planar sheet of material having separating means for allowing the planar sheet of material to be severed into a desired shape.

2. The device of claim 1 wherein the separating means comprises apertures are sized to permit the planar sheet of material to be easily severed into a shape to conform to an irregular contour.

3. The device of claim 1 wherein said planar sheet of material is flexible.

4. The device of claim 1 wherein said planar sheet of material includes means for depositing an image thereon.

5. The device of claim 1 wherein the planar sheet of material includes dimples that extend outwardly such that they can record a pattern when pressed against the surface of an object.

6. The device of claim 1 wherein said planar sheet of material formed out of paper.

7. The device of claim 1 wherein said planar sheet is formed out a fibrous material.

8. The device of claim 1 wherein said planar sheet of material having a tacky surface.

9. A device for making patterns comprising a flexible planar sheet of material effective for placement along the surface contour of an object and a press having a surface for pressing against and severing the planar sheet of material along the surface contour of the object.

10. The device of claim 9 wherein the device for making pattern is formed into sheets of material.

11. The device of claim 9 wherein the device for making patterns is formed into a continuous roll.

12. A method of making a pattern comprising the steps of holding a planar sheet of material against a surface of an object; and pressing down along the edge of the object to sever the planar sheet of material along the edge of the object to form a pattern; wherein the planar sheet of material having means for easily separating along the edge of the object.

13. The method of claim 12 further comprising the step of using a press for pushing against and sever the planar sheet of material along the edge of an object.

14. A method of making a pattern comprising the steps of holding a planar sheet of material having perforations extending outwardly from the planar sheet of material, placing an object along the upper surface of the planar sheet of material, and pressing downwardly on the object such that the planar sheet of material records a pattern thereon.

15. The method of claim 14 further comprising the step of cutting the planar sheet of material along the edge of the pattern recorded thereon.
